(19) United States
(12) Patent Application Publication
(10) Pub. No.: US 2026/0086310 A1
(43) Pub. Date: Mar. 26, 2026

(54) OPTICAL FIBER CABLE HAVING CENTRAL TUBE WITH REDUCED FIBER MOVEMENT

(71) Applicant: CORNING RESEARCH & DEVELOPMENT CORPORATION, Corning, NY (US)

(72) Inventors: Michael Alexander Heinz, Berlin (DE); Gerhard Gernot Merbach, Neustadt bei Coburg (DE); Martina Petra Richter-Bühling, Neustadt bei Coburg (DE)

(21) Appl. No.: 19/179,223

(22) Filed: Apr. 15, 2025

Related U.S. Application Data
(63) Continuation of application No. PCT/US2023/034425, filed on Oct. 4, 2023.
(60) Provisional application No. 63/416,999, filed on Oct. 18, 2022.

(51) Int. Cl. G02B 6/44; G02B 6/04

(52) U.S. Cl. CPC G02B 6/4432; G02B 6/04; G02B 6/4486

(57) ABSTRACT

Embodiments of the disclosure relate to an optical fiber cable. The optical fiber cable includes a cable jacket having a first inner surface and a first outer surface. The first inner surface defines a first central bore extending along a length of the optical fiber cable, and the first outer surface defines an outermost surface of the optical fiber cable. A buffer tube is disposed within the first central bore, and the buffer tube has a second inner surface and a second outer surface. The second inner surface defines a second central bore having an inner diameter and extending along the length of the buffer tube. A plurality of optical fibers is disposed within the second central bore of the buffer tube. A first yarn and a second yarn are disposed within the second central bore and are wrapped around the plurality of optical fibers.

### CROSS-REFERENCE TO RELATED APPLICATIONS

This application is a continuation of International Application No. PCT/US2023/034425 filed on October 4, 2023, which claims the benefit of priority of U.S. Provisional Application No. 63/416,999 filed on October 18, 2022, the content of which is relied upon and incorporated herein by reference in its entirety.

### BACKGROUND

The disclosure relates generally to optical fiber cables and, in particular, to optical fiber cables including optical fibers wrapped with yarns within a buffer tube. Optical fiber cables are deployed at a variety of different angles and orientations. Over long distances, an optical fiber cable may be arranged substantially horizontally such that the components within the cable are not at risk of adverse movement under the influence of gravity. However, within a building, optical fibers may be run between floors, which may be separated by large vertical distances. In such orientations, the optical fibers may not be coupled to the buffer tube or cable jacket in such a way as to prevent sliding of the optical fibers relative to the other structures in the optical fiber cable. This can lead to optical fibers sliding out to an inconvenient degree, if not totally, from the optical fiber cable. Further, currently available means to couple the optical fibers to the buffer tube, such as gels, decrease the flame retardant performance of the optical fiber cable, which is not desirable especially in indoor applications.

### SUMMARY

According to an aspect, embodiments of the disclosure relate to an optical fiber cable. The optical fiber cable includes a cable jacket having a first inner surface and a first outer surface. The first inner surface defines a first central bore extending along a length of the optical fiber cable, and the first outer surface defines an outermost surface of the optical fiber cable. A buffer tube is disposed within the first central bore, and the buffer tube has a second inner surface and a second outer surface. The second inner surface defines a second central bore having an inner diameter and extending along the length of the buffer tube. A plurality of optical fibers is disposed within the second central bore of the buffer tube. A first yarn and a second yarn are wrapped around the plurality of optical fibers.

According to another aspect, embodiments of the disclosure relate to a method. In the method, a plurality of optical fibers is arranged in a group. A first yarn and a second yarn are counter-helically wrapped around the plurality of optical fibers, and a buffer tube is formed around the plurality of optical fibers, the first yarn, and the second yarn.

According to a further aspect, embodiments of the disclosure relate to a subunit. The subunit includes a buffer tube having an inner surface and an outer surface. The inner surface defines a central bore extending along a length of the buffer tube. A plurality of optical fibers is disposed within the central bore of the buffer tube. A first yarn and a second yarn are disposed within the central bore of the buffer tube, and the first yarn and the second yarn are counter-helically wrapped around the plurality of optical fibers.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts a cross-sectional view of an optical fiber cable having optical fibers counter-helically wrapped with two yarns, according to an exemplary embodiment;

FIG. 2 depicts a flow diagram of a method of preparing an optical fiber cable, according to an exemplary embodiment;

FIG. 3 depicts two yarns counter-helically wrapped around a group of optical fibers, according to an exemplary embodiment;

FIG. 4 depicts a graph of fiber movement within a buffer tube in a vertical suspension test for cables having a length of 3 m as a function of time, including samples prepared according to exemplary embodiments;

FIG. 5 depicts a graph of fiber movement within a buffer tube in a vertical suspension test for cables having a length of 17.3 m as a function of time, including samples prepared according to exemplary embodiments; and

FIG. 6 depicts a graph of fiber pullout force within a buffer tube for optical fiber cables in a variety of orientations and having a variety of lengths, including samples prepared according to exemplary embodiments.

### DETAILED DESCRIPTION

Referring generally to the figures and to the following description, various embodiments of an optical fiber cable configured for vertical installations are provided. As will be discussed more fully below, the optical fiber cable includes optical fibers having two yarns wrapped therearound to increase the friction between the wrapped optical fibers and the buffer tube of the optical fiber cable. In this way, the yarn-wrapped optical fibers resist sliding out of the buffer tube when the optical fiber cable is oriented vertically. The yarns wrapped around the optical fibers are selected based on a certain degree of “fluffiness,” which as will be discussed more fully below can be described using the concept of packing factor and/or a combination of linear density and diameter, allowing for a relatively large diameter with a relatively high degree of compressibility. In this way, the yarns frictionally engage the buffer tube without creating attenuation on the optical fibers. Exemplary embodiments of such an optical fiber cable and a method for forming same will be described in greater detail below and in relation to the figures provided herewith, and these exemplary embodiments are provided by way of illustration, and not by way of limitation.

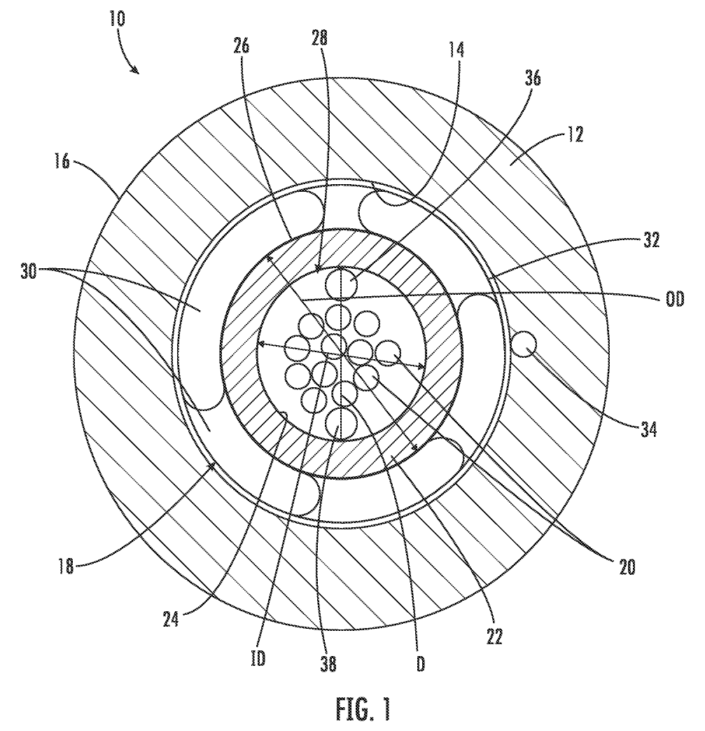

FIG. 1 depicts an example embodiment of an optical fiber cable 10. The optical fiber cable 10 includes a cable jacket 12 having a first inner surface 14 and a first outer surface 16. The first inner surface 14 defines a first central bore 18 that extends along the length of the optical fiber cable 10. The first outer surface 16 defines an outermost surface of the optical fiber cable 10.

In one or more embodiments, the cable jacket 12 includes one or more layers between the first inner surface 14 and the first outer surface 16. For example, the cable jacket 12 may include a layer of bedding compound as an inner layer (defining the first inner surface 14) and a substantially polymeric layer as an outer layer (defining the first outer surface 16). In one or more embodiments, the difference between layers within the cable jacket 12 is related to the level of filler (in particular, flame retardant filler) contained in each layer. That is, an inner bedding layer may contain more filler (e.g., ≥ 40 wt% filler) than the outer polymeric layer (e.g., < 40 wt% filler). In this way, the bedding layer may provide improved flame retardant performance, while the outer layer provides enhanced mechanical robustness. Further, in one or more embodiments, the cable jacket 12 may include other layers, such as binding layers to join an inner layer to an outer layer or a layer that provides an additional functionality, such as a layer of aversive material to repel rodents or a skin layer to reduce friction during installation, amongst other possibilities.

In any case, the outermost layer of the cable jacket 12 defines the first outer surface 16 (i.e., the outermost surface of the optical fiber cable 10), and the innermost layer of the cable jacket 12 defines the first inner surface 14 of the optical fiber cable 10. In embodiments having a single layer cable jacket 12, the single layer is both the outermost layer and the innermost layer and therefore defines both the first outer surface 16 and the first inner surface 14.

Disposed within the first central bore 18 are a plurality of optical fibers 20. In one or more embodiments, the optical fibers 20 are contained within a subunit, such as a buffer tube 22. In the embodiment depicted, there is a single buffer tube 22, and the optical fiber cable 10 may be referred to as a “central tube cable.” The buffer tube 22 includes a second inner surface 24 and a second outer surface 26. The second inner surface 24 defines a second central bore 28. In embodiments of the central tube cable, the second central bore 28 is substantially concentric with the first central bore 18, and the optical fibers 20 are disposed within the second central bore 28, which is disposed within the first central bore 18. In one or more embodiments, the optical fiber cable 10 includes from two to thirty-six, in particular from two to twelve, optical fibers 20. In one or more embodiments, the optical fibers 20 are arranged in the buffer tube 22 in a loose configuration. In such embodiments, the optical fiber cable 10 may be referred to as a “central loose tube cable.”

Further, while only one buffer tube 22 is depicted, the optical fiber cable 10, in one or more other embodiments, includes multiple buffer tubes 22, each carrying a plurality of optical fibers 20. In one or more such embodiments, the buffer tubes 22 extend substantially straight (i.e., are not stranded) along the length of the optical fiber cable 10. Further, in one or more such embodiments, the buffer tubes 22 may be positioned around a central strength member, such as a fiber-reinforced plastic rod.

In one or more embodiments, the optical fiber cable 10 includes other structures positioned within the first central bore 18 between the buffer tube 22 and the cable jacket 12. In one or more embodiments, including the embodiment depicted, the optical fiber cable 10 includes a plurality of strength elements 30 wrapped around the second outer surface 26 of the buffer tube 22. In one or more embodiments, the strength elements 30 are yarns formed from, e.g., aramid, basalt, or glass fibers. In one or more embodiments, the optical fiber cable 10 includes from two to ten strength elements 30 wrapped around the buffer tube 22. In embodiments including multiple buffer tubes 22, the number of strength elements 30 may be increased to provide a substantially complete layer around the buffer tubes 22.

In one or more embodiments, the optical fiber cable 10 includes a water blocking element, such as a water blocking tape 32 wrapped around the strength elements 30. In one or more embodiments, the water blocking element is superabsorbent polymer (SAP) powder applied to the strength elements 30 or around the buffer tube 22, and in one or more embodiments, the water blocking element 32 is incorporated into the strength elements 30, such as by using strengthening yarns impregnated with a water blocking resin. In one or more embodiments, the water-blocking element is a combination of the foregoing (e.g., one or more of water-blocking tape, SAP powder, or impregnated yarns). The water blocking element is not a gel material, and embodiments of the optical fiber cable 10 may be referred to as a “dry central loose tube cable.”

In one or more embodiments, the optical fiber cable 10 includes an access feature, such as a ripcord 34. In one or more embodiments, the access feature is embedded in the cable jacket 12 between the first inner surface 14 and the first outer surface 16. As shown in FIG. 1, the optical fiber cable 10 includes an access feature in the form of a ripcord 34 embedded in the cable jacket 12.

In one or more embodiments, the optical fiber cable 10 is utilized in vertical installations, in particular without service loops. When a conventional optical fiber cable is positioned vertically, the optical fibers have a tendency to slide out of the buffer tube, which creates problems during installation. Attempts to address this problem involved using a gel material in the buffer tube to increase the friction between the optical fibers and the inner surface of the buffer tube. However, the gel material has a negative effect on the burn performance of the optical fiber cable, and further, the gel material is messy during installation. Accordingly, it is preferable to provide a dry tube optical fiber cable.

In that regard, the optical fiber cable 10 disclosed herein includes a first yarn 36 and a second yarn 38 wound around the optical fibers 20. In one or more embodiments, the yarns 36, 38 are formed from fibers of at least one of polyester, glass, cotton, flax, or aramid.

In one or more embodiments, the yarns 36, 38 have a linear density of 250 dtex to 3300 dtex, in particular 300 dtex to 2500 dtex, and most particularly 400 dtex to 1500 dtex. In one or more embodiments, the linear density may vary within the above ranges depending on the inner diameter of the buffer tube 22 as described below.

Further, in one or more embodiments, the yarn 36, 38 is selected to be “fluffy” so as to enhance the friction between the wrapped optical fibers 20 and the buffer tube 22 without increasing attenuation. In one or more embodiments, the “fluffiness” of the yarns 36, 38 can be described in terms of a yarn packing factor, which is the cumulative area of all the fibers within the yarn divided by the yarn cross sectional area. In one or more embodiments, the packing factor is 0.5 or less, in particular 0.4 or less, and more particularly 0.3 or less.

In one or more embodiments, the yarns 36, 38 each have a diameter of 0.1 mm to 0.5 mm, in particular a range of 0.15 mm to 0.4 mm.

In one or more embodiments, at least one of the first yarn 36 or the second yarn 38 is a water-blocking yarn (e.g., the yarn 36, 38 is impregnated with a water blocking resin or is coated with SAP powder).

In one or more embodiments, the first yarn 36 is wound around the optical fibers 20 in a first direction, and the second yarn 38 is wound around the optical fibers 20 in a second direction that is opposite to the first direction. For example, the first yarn 36 may be wound clockwise around the optical fibers 20, and the second yarn 38 is wound counterclockwise around the optical fibers 20. In this way, the first yarn 36 and second yarn 38 are counter-helically wound around the optical fibers 20. Advantageously, the counter-helical wrapping means that the yarns 36, 38 only meet at the points where the counter helices cross, which produces regions where the fibers are slightly off center within the grouping, promoting sagging and kinking (and therefore further engagement with the second inner surface 24 of the buffer tube 22).

In one or more embodiments, the optical fiber cable 10 includes one or more additional yarns within the buffer tube 22. In one or more such embodiments, the one or more additional yarns may be wrapped with the first yarn 36 and the second yarn 38 or may run adjacent to the optical fibers 20 wrapped with the first and second yarns 36, 38. The one or more additional yarns may serve to increase the friction between the wrapped optical fibers 20 and the buffer tube 22 or to provide a water-blocking element, e.g., if the yarns 36, 38 are not already provided with water-blocking functionality.

The second inner surface 24 of the buffer tube 22 defines an inner diameter ID of the buffer tube 22. In one or more embodiments, the inner diameter ID is from 1.0 mm to 2.4 mm. In one or more particular embodiments, the inner diameter ID is about 1.75 mm. The second outer surface 26 of the buffer tube 22 defines an outer diameter OD of the buffer tube 22. In one or more embodiments, the outer diameter OD of the buffer tube 22 is from 1.4 mm to 3.0 mm. In one or more particular embodiments, the outer diameter OD of the buffer tube is about 2.25 mm. The buffer tube 22 has a thickness between the second inner surface 24 and the second outer surface 26. In one or more embodiments, the thickness of the buffer tube 22 is from 0.15 mm to 0.60 mm. In one or more particular embodiments, the thickness of the buffer tube 22 is about 0.25 mm.

As shown in FIG. 1, the optical fibers 20 wrapped in the first yarn 36 and the second yarn 38 have a maximum cross-sectional dimension D. In one or more embodiments, the maximum cross-sectional dimension D is at least 70% of the inner diameter ID of the buffer tube 22 (i.e., D ≥ 0.7ID). In this way, the wrapped optical fibers 20 engage the second inner surface 24 of the buffer tube 22. In one or more embodiments, the maximum cross-sectional dimension D is at least 80% or at least 90% of the inner diameter ID of the buffer tube 22. In one or more embodiments, the maximum cross-sectional dimension D is up to 100% of the inner diameter ID of the buffer tube 22 (i.e., D = ID). For a given number of optical fibers 20, the linear density, packing factor, and/or diameter of the yarns 36, 38 may be selected to increase or decrease the maximum cross-sectional dimension D relative to the inner diameter ID of the buffer tube 22 to achieve the desired relationship (e.g., at least 0.7ID, at least 0.8ID, at least 0.9 ID, or up to 1ID).

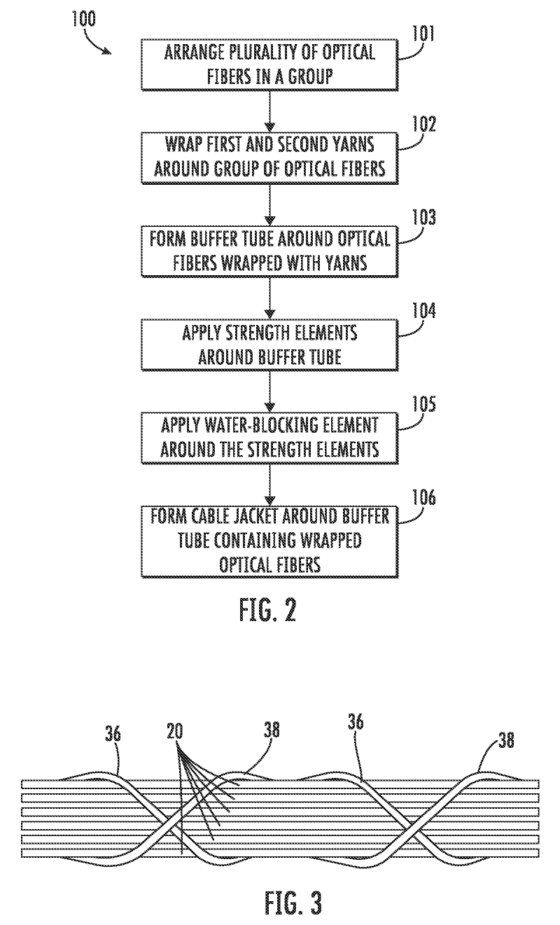

FIG. 2 depicts a flow diagram of a method 100 for preparing an optical fiber cable 10 as described above. In a first step 101 of the method 100, the optical fibers 20 are grouped on a process line. In a second step 102 of the method, the grouped optical fibers 20 are wrapped with the first yarn 36 and the second yarn 38. In one or more embodiments, the first yarn 36 and the second yarn 38 are counter-helically wrapped around the optical fibers 20. In a third step 103, the buffer tube 22 is formed, e.g., extruded, around the wrapped optical fibers 20. In one or more embodiments, the method 100 includes a fourth step 104 in which the strength elements 30 are applied around the buffer tube 22, such as by wrapping or winding the strength elements around the buffer tube 22. In one or more embodiments, the method 100 includes a fifth step 105 in which the water-blocking element, such as a water-blocking tape 32, is applied around the strength elements 30, such as by wrapping or winding the water-blocking tape 32 around the strength elements 30. However, as discussed above, the strength elements 30 may include a water-blocking element, such that the fourth step 104 and the fifth step 105 are performed concurrently. In a sixth step 106, the cable jacket 12 is formed, e.g., extruded, around buffer tube 22 and any included strength elements 30 or water blocking elements. During the sixth step 106, the access feature, such as the ripcord 34, may be embedded in the cable jacket 12. Further, in embodiments in which the cable jacket 12 is a multi-layer structure, the layers may be formed concurrently, e.g., using an extrusion die configured to extruded multiple materials concentrically. Alternatively, one or more of the layers of the cable jacket 12 may be formed in successive forming (e.g., extrusion) steps.

The steps 101-106 of the method 100 may be performed in succession, or the steps may be broken up on different processing lines. For example, steps 101-103 may be performed on a first processing line such that the optical fibers 20 are grouped, the yarns 36, 38 are wrapped around the optical fibers 20, and the buffer tube 22 is formed around the wrapped optical fibers 20 in a substantially continuous manner. The buffer tube 22 so formed may be cooled, e.g., in a water trough, and taken up on a spool for storage and transportation. Thereafter, in one or more embodiments, steps 104-106 may be performed on a second processing line such that the buffer tube 22 is wrapped with the strength elements 30 and water-blocking element and the cable jacket 12 is formed around the buffer tube 22 in a substantially continuous manner. The optical fiber cable 10 so formed may be cooled, e.g., in a water trough, and taken up on another spool for storage and transportation.

FIG. 3 depicts the first yarn 36 and second yarn 38 counter-helically wrapped around a group of optical fibers 20. That is, as discussed above, the first yarn 36 is helically wrapped around the optical fibers 20 in a first direction, and the second yarn 38 is helically wrapped around the optical fibers 20 in a second direction that is opposite to the first direction. This helical wrapping of the yarns 36, 38 in different directions is referred to as “counter-helical wrapping.” As can be seen in FIG. 3, wrapping the yarns 36, 38 in a counter-helical manner causes the yarns 36, 38 to cross at various points along the length of the group of optical fibers 20. The crossover points may be at regular or irregular intervals along the length of the optical fibers 20.

As mentioned above, in conventional optical fiber cables, the optical fibers slide out of the buffer tube when the optical fiber cable is arranged vertically. In order to compare the ability of the disclosed optical fiber cable 10 to maintain the positioning of the optical fibers 20 within the buffer tube 22 to such conventional optical fiber cables, several samples having lengths varying from 3 m to 17.3 m were prepared to test their performance in the vertical orientation.

In a first experiment, a 3 m length of a conventional optical fiber cable was prepared in which the optical fibers were loosely provided in the buffer tube. For comparison, a 3 m length of an optical fiber cable 10 according to the present disclosure was prepared. The conventional sample and the sample according to the present disclosure were arranged vertically, and the optical fibers of the conventional sample immediately slid out of the buffer tube when put in the vertical orientation. In contrast, the optical fibers 20 of the sample according to the present disclosure did not slide out from the buffer tube 22 by more than a few millimeters even after 96 hours.

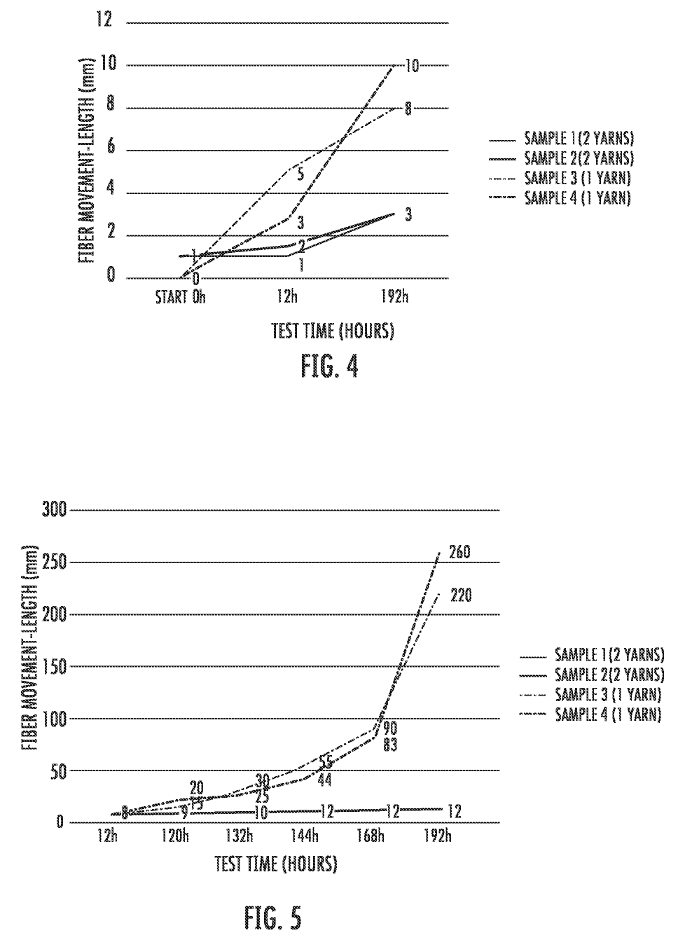

Additional samples were prepared to test the performance of the optical fibers wrapped with one yarn versus two yarns. In particular, four samples having the same general construction were prepared. Two of the samples (Samples 1 and 2) included two yarns counter-helically wrapped around the optical fibers, according to the present disclosure, and two of the samples (Samples 3 and 4) included one yarn helically wrapped around the optical fibers. The four samples were suspended a vertical distance of 3 m on a vibration plate. FIG. 4 provides a graph of the optical fiber movement out of the buffer tube as a function of time for each of the samples. As can be seen in FIG. 4, the samples having two counter-helically wrapped yarns moved only 3 mm after 192 hours of vertical suspension on the vibration plate. The samples having only a single, helically-wrapped yarn moved up to 10 mm out of the buffer tube.

Based on the performance of the samples, larger lengths of optical fiber cable were prepared and tested. In particular, two samples (Samples 1 and 2) having two, counter-helically wrapped yarns according to the present disclosure were prepared, and two samples (Samples 3 and 4) having a single, helically-wrapped yarn were also prepared. The four samples had lengths of approximately five stories, or 17.3 m. FIG. 5 provides a graph of the optical fiber movement out of the buffer tube as a function of time for each of the samples. From FIG. 5, it can be seen that the performance of the two-yarn embodiment departs significantly from the single yarn embodiments at longer lengths over long time periods. In particular, FIG. 5 shows that after 192 hours the fibers moved only 12 mm out of the buffer tube when the optical fibers were counter-helically wrapped with two yarns (Samples 1 and 2). In contrast, the movement of the optical fibers out of the buffer tube in the single yarn embodiments accelerates, and by 192 hours, the optical fibers have slid out of the buffer tube a distance of over 200 mm. Specifically, the two samples having a single, helically-wrapped yarn experienced optical fiber movement of 220 mm (Sample 3) and 260 mm (Sample 4).

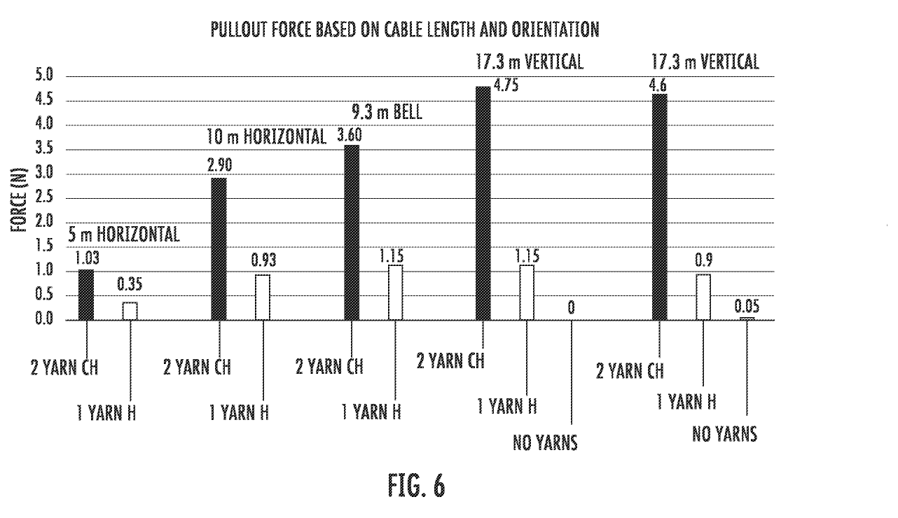

The performance of the optical fiber cable having a single, helically-wrapped yarn around the optical fibers and of the optical fiber cable according to the present disclosure having two, counter-helically wrapped optical fibers was further characterized based on the force required to pull the optical fibers out of the buffer tube. The force was tested for the optical fiber cables in different orientations. In particular, the pull-out force was determined for 5 m lengths of optical fiber cable in a horizontal orientation, 10 m lengths of optical fiber cable in a horizontal orientation, 9.3 m lengths of optical fiber cable in a bell-shaped profile, 17.3 m lengths of optical fiber cable in a vertical orientation, and 17.3 m lengths of optical fiber cable in a horizontal orientation. The results of the test are summarized in the graph of FIG. 6.

As can be seen in FIG. 6, the optical fiber cables having two, counter-helically wrapped yarns required greater force to pull the optical fibers out from the buffer tubes. In the 5 m horizontal orientation, the optical fibers with two, counter-helically wrapped yarns (2 Yarn CH) required a force of 1.03 N to pull from the buffer tube, whereas the optical fibers with a single, helically-wrapped yarn (1 Yarn H) required only a force of 0.35 N. As the length of the cables increased, so did the force required. For the optical fibers having two, counter-helically wrapped optical yarns (2 Yarn CH), the force increased to 2.9 N (10 m horizontal), 3.6 N (9.3 m bell profile), 4.75 N (17.3 m vertical), and 4.6 N (17.3 m horizontal). For the optical fibers having a single, helically-wrapped yarn (1 Yarn H), the forced increased to a lesser extent to 0.93 N (10 m horizontal), 1.15 N (9.3 m bell profile), 1.15 N (17.3 m vertical), and 0.9 N (17.3 m horizontal). For additional comparison, two optical fiber cable samples having no yarns (i.e., loose optical fibers within the buffer tube) were prepared and tested for the pullout force at lengths of 17.3 m in the vertical and horizontal orientations. As can be seen in FIG. 6, no measurable force was detected for pullout in the vertical orientation, and only a force of 0.5 N was required in the horizontal orientation.

Thus, according to the present disclosure, an optical fiber cable 10 having optical fibers 20 counter-helically wrapped with yarns 36, 38 provides a degree of frictional engagement with the buffer tube 22 to prevent the optical fibers 20 from sliding out of the buffer tube 22 when the optical fiber cable 10 is in a vertical installation. In particular, application of a force of at least 0.5 N, in particular at least 0.75 N, and most particularly at least 1 N, is required to pull the optical fibers 20 counter-helically wrapped with the yarns 36, 38 out from a 5 m length of cable in a horizontal orientation. Advantageously, the yarns 36, 38 may provide a water-blocking element, and the optical fiber cable 10 does not require the use of a gel filler, which diminishes the fire retardant performance of the optical fiber cable 10.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article "a" is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber cable, comprising:
a cable jacket comprising a first inner surface and a first outer surface, the first inner surface defining a first central bore extending along a length of the optical fiber cable and the first outer surface defining an outermost surface of the optical fiber cable;
a buffer tube disposed within the first central bore, the buffer tube comprising a second inner surface and a second outer surface, the second inner surface defining a second central bore extending along the length of the buffer tube;
a plurality of optical fibers disposed within the second central bore of the buffer tube; and
a first yarn and a second yarn disposed within the second central bore, the first yarn and the second yarn being wrapped around the plurality of optical fibers.

2. The optical fiber cable of claim 1, wherein the second inner surface defines an inner diameter of the buffer tube and wherein a maximum cross-sectional dimension of the plurality of optical fibers having the first yarn and the second yarn wrapped therearound is equal to at least 70% of the inner diameter of the buffer tube.

3. The optical fiber cable of claim 1, wherein the first yarn and the second yarn each comprise a packing factor of 0.5 or less.

4. The optical fiber cable of claim 1, wherein the first yarn and the second yarn each comprise a linear density in a range from 250 dtex to 3300 dtex.

5. The optical fiber cable of claim 1, wherein the first yarn and the second yarn each have a diameter of 0.1 mm to 0.5 mm.

6. The optical fiber cable of claim 1, wherein the first yarn and the second yarn are counter-helically wrapped around the plurality of optical fibers.

7. The optical fiber cable of claim 1, wherein the first yarn and the second yarn each comprise fibers selected from the group consisting of polyester, glass, cotton, flax, and aramid.

8. The optical fiber cable of claim 1, wherein at least one of the first yarn and the second yarn comprises a superabsorbent polymer powder or is impregnated with a water-blocking resin.

9. The optical fiber cable of claim 1, wherein a force required to pull the plurality of optical fibers having the first and second yarns wrapped therearound out from a section of cable having a length of 5 m and arranged in a horizontal orientation is at least 0.5 N.

10. The optical fiber cable of claim 1, wherein the second central bore of the buffer tube contains no gel material.

11. A method, comprising:
arranging a plurality of optical fibers in a group;
counter-helically wrapping a first yarn and a second yarn around the plurality of optical fibers; and
forming a buffer tube around the plurality of optical fibers, the first yarn, and the second yarn.

12. The method of claim 11, wherein the first yarn and the second yarn each comprise fibers selected from the group consisting of polyester, glass, cotton, flax, and aramid.

13. The method of claim 11, wherein the first yarn and the second yarn each have a packing factor of 0.5 or less.

14. The method of claim 11, wherein the first yarn and the second yarn each have a linear density in a range from 250 dtex to 3300 dtex.

15. The method of claim 11, wherein the first yarn and the second yarn each have a diameter of 0.1 mm to 0.5 mm.

16. The method of claim 11, further comprising forming a cable jacket around the buffer tube to provide an optical fiber cable, the cable jacket comprising an outer surface that is an outermost surface of the optical fiber cable.

17. The method of claim 14, further comprising applying at least one of strength elements or a water-blocking element around the buffer tube prior to forming the cable jacket.

18. The method of claim 11, wherein an inner surface of the buffer tube defines an inner diameter of the buffer tube and wherein a maximum cross-sectional dimension of the plurality of optical fibers having the first yarn and the second yarn counter-helically wrapped therearound is equal to at least 70% of the inner diameter of the buffer tube.

19. The method of claim 11, wherein at least one of the first yarn or the second yarn comprises a superabsorbent polymer powder or is impregnated with a water-blocking resin.

20. The method of claim 11, wherein the buffer tube is formed so as not to contain a gel material.
